(19) United States
(12) Patent Application Publication
(10) Pub. No.: US 2018/0093434 A1
(43) Pub. Date: Apr. 5, 2018

(54) Method for Producing a Composite Fiber Component with an Integrated Screw-In Insert

(71) Applicant: Bayerische Motoren Werke Aktiengesellschaft, Muenchen (DE)

(72) Inventor: Martin SCHINDLBECK, Neufahrn (DE)

(21) Appl. No.: 15/830,040

(22) Filed: Dec. 4, 2017

Related U.S. Application Data
(63) Continuation of application No. PCT/EP2016/064827, filed on Jun. 27, 2016.

(30) Foreign Application Priority Data
Sep. 28, 2015 (DE) 10 2015 218 593.1

(51) Int. Cl. B29C 70/86; B29C 70/46; B29C 70/54; B29C 70/82; F16B 35/00

(52) U.S. Cl. CPC B29C 70/86; B29C 70/46; B29C 70/545; B29L 2001/00; F16B 35/00; B29C 2793/0045; B29C 70/82

(57) ABSTRACT

A method is provided for producing a composite fiber component with an integrated screw-in insert. A pressing tool is provided. The pressing tool has a first tool part and a second tool part that can be moved in relation to the first tool part. The parts form a cavity for receiving and forming a fiber preform, when the pressing tool is closed. A screw-in insert is connected to a screw device integrated into the first tool part. The fiber preform is arranged between the first and the second tool parts. The pressing tool is at least partially closed. The screw device is actuated in order to screw the screw-in insert into the fiber preform. The fiber preform is cured.

### CROSS REFERENCE TO RELATED APPLICATIONS

This application is a continuation of PCT International Application No. PCT/EP2016/064827, filed Jun. 27, 2016, which claims priority under 35 U.S.C. § 119 from German Patent Application No. 10 2015 218 593.1, filed Sep. 28, 2015, the entire disclosures of which are herein expressly incorporated by reference.

### BACKGROUND AND SUMMARY OF THE INVENTION

The invention relates to a method for producing a fiber-composite component having an integrated screw-in insert, to a respective screw-in insert, and to a pressing tool for carrying out the method.

In order for fiber-composite components to be connected with other components it is known for fastening points which are disposed on or in the fiber-composite components to be provided. The fastening points usually comprise special connecting means such as bolts, screws, or nuts, which as linking elements enable a connection to the other components.

These linking elements in post-production operating steps are typically attached to already fully completed and cured fiber-composite components, on account of which a significant additional complexity in terms of preparing the connecting surfaces by boring, milling, machining, sanding, cutting, and cleaning, and in terms of the actual connecting by way of adhesive surface bonding is created. The connection in this case is provided merely by the materially integral connection and in terms of the strength of said connection is limited in a corresponding manner.

Accordingly, this approach is time-intensive and on account of the subtractive machining and depending on the connecting means chosen causes damage to the laminated construction, reducing a strength of the entire component produced.

In order for this to be avoided, methods in which the linking elements are already fastened to the fiber-composite component within the production process of the latter are known. To this end, an incorporation of the linking element, typically carried out manually in preliminary textile processes, is performed, in particular in the case of the layered construction of layered assemblies, in that the linking elements are placed between the individual tiers. However, said processes usually have to be interrupted for the placing of the linking elements, the consequence thereof being that cycle rates are significantly reduced. Moreover, stitching of the linking elements and perforating individual fibrous tiers are required in most instances. The layered assemblies produced in this manner are subsequently laid up in a pressing tool and are formed to the component by means of wet pressing at a high pressure. There is the additional risk herein of the linking elements that are merely placed or stitched therein sliding or at least not being able to be positioned in a reproducible manner by virtue of inevitable play, on account of which high requirements in terms of tolerances that are to be met by the fiber-composite component are not implementable.

It is therefore an object of the invention to connect a linking element to a fiber-composite component in such a manner that the fiber-composite component can be processed in as automated a manner as possible, meets high requirements in terms of tolerances, and is producible in a simple and as far as possible a cost-effective manner.

This and other objects are achieved by a method, by a screw-in insert, and by a pressing tool in accordance with the embodiments of the invention.

Accordingly, a method for producing a fiber-composite component having an integrated screw-in insert is provided, said method comprising at least the following acts:
providing a pressing tool having a first tool part and a second tool part that is movable relative to the former, said first tool part and said second tool part in a closed state of the pressing tool forming a cavity for receiving a fibrous semi-finished product in a shape-imparting manner;
connecting a screw-in insert to a screw-driving device that is integrated in the first tool part;
disposing the fibrous semi-finished product between the first and the second tool part;
at least partially closing the pressing tool;
activating the screw-driving device for screwing the screw-in insert into the fibrous semi-finished product; and
curing the fibrous semi-finished product in order for the fiber-composite component to be generated.

The method thus provides for a linking element to be incorporated in the fibrous semi-finished product and to be integrated in the latter in that the linking element is driven into the fibrous semi-finished product, or is screwed into the latter, respectively. Accordingly, the linking element hereunder will be referred to as an insert or as a screw-in insert.

The screw-in insert is first connected to the screw-driving device in order to be subsequently screwed into the fibrous semi-finished product by way of the screw-driving device. Connecting can be inserting into the screw-driving device for example, or preferably by way of a form-fitting engagement of the screw-driving device of a corresponding design, in the screw-in insert, wherein the engagement must be releasable again at the latest for removing the fiber-composite component produced, or already at an earlier point in time. Screwing in can comprise either screwing in by way of a merely partial rotational movement, or screwing in by way of one or a plurality of revolutions.

The screw-driving device can be integrated in the first tool part in order for the screw-in insert to be able to be screwed into the fibrous semi-finished product also in the at least partially closed state of the pressing tool. The integration of the screw-driving device can be embodied in such a manner that the screw-driving device is provided so as to be flush with a surface of the first tool part that delimits the cavity, or within the first tool part so as to be set back from said surface of the first tool part that delimits the cavity. In order for the screw-in insert to be screwed in, at least a screw-driving element of the screw-driving device, or the entire screw-driving device can be moved at least partially in the direction of the cavity, as will be described in detail further below.

The integration into the tool part enables an accurate and reproducible positioning of the screw-in insert in relation to the pressing tool, on account of which the adherence to high requirements in terms of tolerance is ensured. Moreover, complex adhesive bonding procedures for the adhesively bonded bolts that are usually required otherwise and the corresponding upstream preparation and cleaning measures can be dispensed with.

The fibrous semi-finished product is preferably disposed in the pressing tool in a state in which said fibrous semi-finished product is impregnated with a matrix and is not cured. Since screwing into the fibrous semi-finished product is performed prior to the curing of the fibrous semi-finished product, the matrix is present in the liquid or viscous state such that the fibers of the fibrous semi-finished product can evade the invading screw-in insert, or are displaced by the latter, respectively. In this way, damage to the fibrous structure and to the later laminated composite of the fiber-composite component produced therefrom, such as would arise otherwise, for example when boring in a cured state of the fibrous semi-finished product, is avoided. Corrosion issues associated therewith, and water ingress, and complex sealing of bore holes can be dispensed with.

The first tool part is preferably formed by an upper tool, and the second tool part is preferably formed by a lower part of the pressing tool. Alternatively, however, in a reversal the first tool part can be embodied as the lower tool, and the second tool part can be embodied as the upper tool. It is understood that in any case the first and/or the second tool part can in each case be made from one or from a plurality of pieces.

Of course, it is possible that one or a plurality of further screw-driving devices that are embodied in an analogous manner are additionally integrated in the first tool part in order for a corresponding number of further screw-in inserts to be screwed into the fibrous semi-finished product in the same way. Additionally or alternatively thereto, one or a plurality of the screw-driving devices described can also be integrated in the second tool part in order for a corresponding number of further screw-in inserts to be screwed into the fibrous semi-finished product in the same way. In any case, the steps of connection can thus be repeated for each of the screw-in inserts, either sequentially or simultaneously. The step of activation the screw-driving device on the respective screw-driving device is also repeated so as to correspond to the number of screw-driving devices, either sequentially or simultaneously.

The fibrous semi-finished product can be a woven fabric, a braided fabric, a cross-laid structure, a multi-axial cross-laid structure, an embroidered fabric, a warp/weft-knitted fabric, or a non-woven fabric. Glass fibers, carbon fibers, aramid fibers, plastics fibers, and/or suitable natural fibers, and all arbitrary combinations of the materials mentioned, are suitable fibrous materials.

According to one further embodiment, the fibrous semi-finished product can be a so-called sandwich component having at least two tiers, each from one of the fibrous materials mentioned, which in turn are embodied as a woven fabric, a braided fabric, a cross-laid structure, a multi-axial cross-laid structure, an embroidered fabric, a warp/weft-knitted fabric, or a non-woven fabric. The at least two tiers are formed by an intermediate layer from filler material, such as a plastic, metal, or natural materials. The intermediate layer can comprise cavities, for example in the form of a honeycomb structure, or a foam material, in particular a foam material from plastics or metal.

In order for the pressing tool to be prepared for curing the fibrous semi-finished product, the act of at least partially closing can comprise completely closing the pressing tool, or an act of completely closing the pressing tool can be performed prior to curing the fibrous semi-finished product.

According to one embodiment, the method comprises reversing at least the screw-driving element of the screw-driving device, or the entire screw-driving device, prior to the pressing tool being opened. This means that the screw-driving device in terms of the engagement of the latter in the screw-in insert is released and at least the screw-driving element is removed from said screw-in insert. In this way, damage to the screw-driving device and/or to the fiber-composite component can be avoided when the pressing tool is being opened and/or the fiber-composite component is being removed.

Furthermore described is a screw-in insert for screwing into a fibrous semi-finished product, wherein the screw-in insert comprises an activation portion, a screw-in shaft that extends away from the activation shaft, and a linking portion.

In particular, the activation portion is configured for connecting to the screw-driving device. For example, the activation portion can have respective clearances and/or appendages for the form-fitting engagement of the screw-driving device and for transmitting a torque. The screw-in shaft is provided for penetrating the fibrous semi-finished product and displacing fibrous material. Said screw-in shaft can optionally also be embodied for at least partially anchoring the screw-in insert in the fibrous semi-finished product. A linking portion is understood to be a portion of the screw-in insert which is provided for linking further components.

To this end, the linking portion can comprise, for example, an internal thread, an external thread, a coupling element, a ball element, a bayonet element, or a clip element. It is understood that this listing is not final and that other known connecting elements which are suitable for linking can also be provided. For example, the linking portion comprises a bore that is disposed in the screw-in insert, the internal thread for screwing in other linking elements being provided in said bore. Alternatively, the linking portion can comprise a cylindrical portion which extends in an opposite direction to that of the screw-in shaft, away from the activation portion, and comprises the external thread which is configured for screw-fitting other connecting elements.

In order for the screw-in insert to be anchored in a reliable manner and so as to be as gentle as possible on the fibrous structure of the fibrous semi-finished product, the screw-in insert can comprise at least one thread blade which is designed for screwing the screw-in insert into the fibrous semi-finished product and anchoring said screw-in insert in the latter. A thread blade is understood to be, for example, a portion that is embodied so as to be blade-shaped and flush, or an appendage that is embodied so as to be blade-shaped and projecting, in any case in the axial screw-in direction (that is to say so as to face away from the activation portion) and/or in the screw-in direction of rotation being shaped so as to engage in the fibrous semi-finished product. The anchoring in the fibrous structure of the fibrous semi-finished product offers the advantage that the fibrous structure is largely maintained, on the one hand. Moreover, this anchoring, in particular in the case of the projecting appendage, increases the forces that are to be absorbed and transmitted by the screw-in insert, such that the fiber-composite component with the aid of the screw-in insert can also be employed for high loads.

According to one embodiment, the screw-in shaft can have a cylindrical portion on which a substantially disk-shaped flange is disposed so as to be spaced apart from the activation portion, wherein the flange in order for the thread blade to be formed has at least one flange portion which projects from a flange plane that is defined by the flange.

The substantially disk-shaped flange is thus at least at one point of the disk-type shape thereof, in the region of the at least one flange portion, shaped in such a manner that the projecting flange portion defines the thread blade by way of which the screw-in insert is screwed into the fibrous semi-finished product. To this end, the projecting flange portion, in a direction facing away from the activation portion is shaped in a manner similar to that of a thread entry point, for example, so as to thus “dig” itself into the fibrous semi-finished product.

The projecting flange portion can be designed in such a manner that said projecting flange portion by way of a plastic deformation is optionally deformable so as to return to the flange plane. In this case, the method and the pressing tool can be embodied in such a manner that one or both tool parts when closing the pressing tool apply a corresponding bending force to the projecting flange portion and deform the latter, preferably after having been screwed into the fibrous semi-finished product, and incorporate said flange portion so as to be flush with the flange plane. To this end, the respective opposite tool part preferably comprises a corresponding structure which defines a detent which deforms the flange portion to the desired position when the pressing tool is being closed.

Alternatively, the substantially disk-shaped flange can have at least one flange portion which is configured so as to be flush with the disk-shaped flange and comprises a clearance for incorporating the fibrous semi-finished product and a blade edge that is adjacent to said clearance in order for the thread blade to be formed. The clearance is thus to be understood as a “slice of cake” cut from the disk-shaped flange, for example, the one edge of said “slice of cake” being embodied as a blade edge and receiving the fibrous semi-finished product when the latter is being screwed in.

In any case, the disk-shaped flange can have a diameter which is smaller than the size of the activation portion. In particular, the diameter of the disk-shaped flange can be smaller than a diameter of the activation portion to the extent that the latter is likewise configured so as to be disk-shaped, as is described hereunder.

Furthermore, the activation portion can have a chamfer that faces away from the disk-shaped flange, and/or the disk-shaped flange can have a chamfer that faces away from the activation portion. In particular, the chamfer of the activation portion facilitates connecting the activation portion to the screw-driving device. By contrast, the chamfer of the disk-shaped flange facilitates screwing into the fibrous semi-finished product in that the fibrous structure is displaced more easily and more gently than as would be the case without the chamfer.

The activation portion is preferably configured so as to be disk-shaped, wherein a receptacle portion for receiving the fibrous semi-finished product is defined between the activation portion and the flange that is disposed so as to be spaced apart. The disk-shaped flange, when being screwed into the fibrous semi-finished product, can at first be screwed through the latter. The fibrous semi-finished product herein in a localized manner is partially displaced and on the rear side of the disk-shaped flange slides into the defined receptacle portion. The screw-in insert in this state by way of the disk-shaped activation portion, on the one hand, and by way of the disk-shaped flange, on the other hand, is fixed to and held on the fibrous semi-finished product in a planar manner such that a load-bearing integration and anchoring are achieved at the latest after curing.

To the extent that the projecting flange portion is provided, the latter, subsequent to screwing-in that has been performed in this way, can optionally be deformed as has been described above. A level lower side of the screw-in insert which is defined by that surface of the disk-shaped flange that faces the second tool is thus produced, this thus avoiding that the screw-in insert be released from the fibrous semi-finished product. Should the projecting flange portion not be deformed, the latter can thus be at least partially enclosed with the matrix.

According to an alternative embodiment, the screw-in shaft can comprise an external thread for screwing into the fibrous semi-finished product, and the at least one thread blade on the activation portion can be disposed so as to be spaced apart in parallel with the screw-in shaft.

In this case, the screw-in shaft ensures the displacement of the fibrous material. Depending on the length of the at least one thread blade, the latter for anchoring engages in the fibrous structure in the fibrous semi-finished product. Therefore, a length of the one or of the plurality of thread blades is in each case preferably shorter than a length of the screw-in shaft.

Moreover, a pressing tool having a first tool part and a second tool part is provided, wherein the two tool parts in the closed state form a cavity for receiving a fibrous semi-finished product in a shape-imparting manner, wherein at least one tool part for screwing a screw-in insert into a fiber-composite component to be disposed in the cavity has a screw-driving device which is activatable in the direction of the cavity.

The screw-driving device can furthermore comprise at least a screw-driving element that is movable in a rotational manner and in a longitudinal manner in the direction of the cavity, said screw-driving element for impinging a screw-in insert in a form-fitting manner being configured with a connecting portion. For example, the screw-driving element can be embodied so as to be pin-shaped and on an end side, for example by way of a respective appendage or a respective clearance for achieving the form-fitting impingement, in order for the screw-in insert to be impinged in a corresponding manner. The screw-driving element can be driven in a rotating manner and, for example, be deployed from the tool part by means of a thread in order for the screw-in insert to be screwed into the fibrous semi-finished product. According to one preferred embodiment, the thread has the same pitch as the at least one thread blade and/or a thread of the screw-in shaft that is potentially provided.

At least the screw-driving element of the screw-driving device, or the entire screw-driving device, is preferably configured so as to be retractable into the tool part. This means that the screw-driving element in a longitudinal manner is movable at least between an initial position and a terminal position. The screw-driving element in the initial position is disposed so as to be moved back into the tool part such that said screw-driving element does not project in relation to a surface of the tool part that is adjacent to the cavity but by way of the connecting portion of said screw-driving element is disposed so as to be flush with the surface or even so as to be set back from the latter. The screw-driving element reaches the terminal position by the screwing movement in the direction of the cavity, as soon as the screw-in element is disposed in the desired position.

The screw-driving device can additionally have a resin-scraping groove such that matrix that potentially adheres to the screw-driving element by virtue of the resin-scraping groove is wiped off in a return movement of the screw-driving element into the tool part, such that any ingress into the screw-driving device can be avoided.

According to one embodiment, the pressing tool is a wet pressing tool.

The screw-driving device can optionally comprise a holder, in particular a magnetic holder or a vacuum holder. This enables fastening of the screw-in insert to the screw-driving device, or to the screw-driving element of the latter, respectively, in an as simple as possible, clean manner without complexity, the screw-driving device or the screw driving element of the latter, respectively, being able to be readily released on demand, for example in order for the fiber-composite component produced to be removed from the pressing tool after having carried out the method steps described, or in order for the screw-driving element to be released from the engagement with the screw-in insert. In particular, it is possible with the aid of this holding means for the screw-in insert to be positioned in a suspended manner if the latter is to be disposed in the upper tool of the pressing tool.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a side view of a screw-in insert in a first embodiment.

FIG. 2 shows a plan view of the screw-in insert from FIG. 1.

FIG. 3 shows a sectional plan view of the screw-in insert from FIG. 1.

FIG. 4 shows a side view of a screw-in insert in a second embodiment.

FIG. 5 shows a sectional side view of the screw-in insert from FIG. 4.

FIG. 6 shows a side view of a screw-in insert in a third embodiment.

FIGS. 7A, 7B, 7C, and 7D show the steps of a method for producing a fiber-composite component having an integrated screw-in insert.

FIG. 8 shows a side view of a screw-in insert in a fourth embodiment.

FIGS. 9A, 9B, 9C, and 9D show the steps of a method for producing a fiber-composite component having an integrated screw-in insert according to FIG. 8.

### DETAILED DESCRIPTION OF THE DRAWINGS

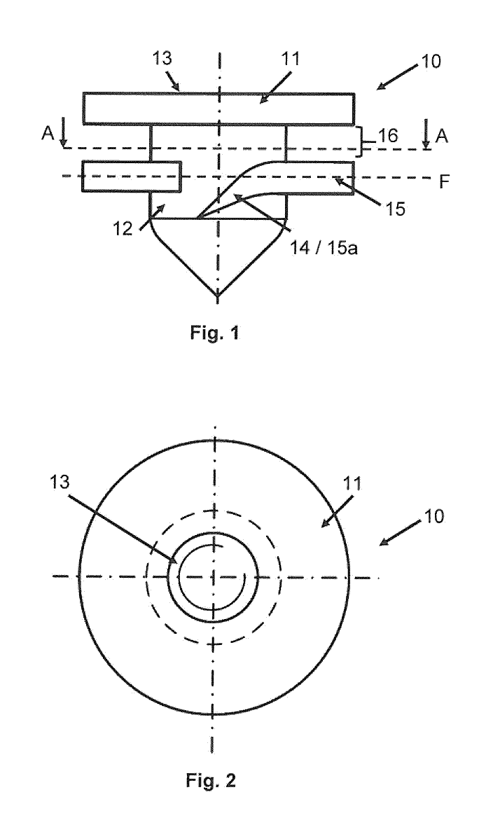

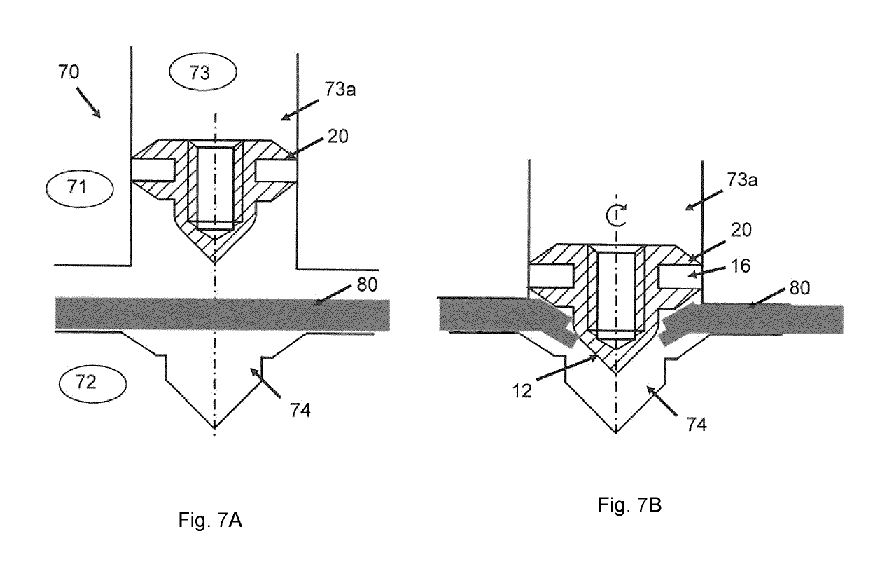

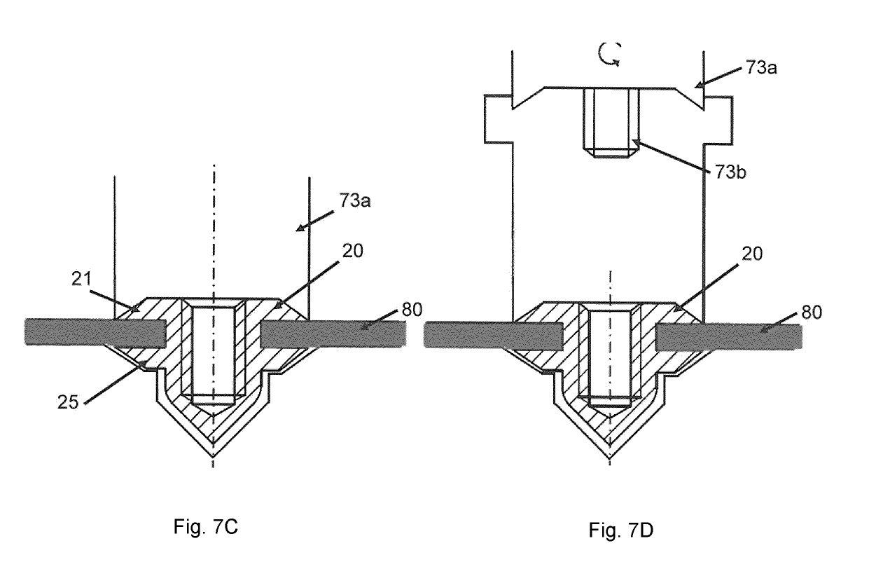

A side view of a screw-in insert 10 in a first embodiment is illustrated in FIG. 1. The screw-in insert 10 is provided for screwing into a fibrous semi-finished product 80 (cf. FIGS. 7A to 7D) and to this end has an activation portion 11 with the aid of which the screw-in insert 10, for example by a screw-driving device (cf. FIGS. 7A to 7C) can be impinged so as to be capable of transmitting a torque and be screwed into the fibrous semi-finished product 80. Moreover, a screw-in shaft 12 that extends away from the activation potion 11 and a linking portion 13 are provided.

The screw-in shaft 12 is provided for penetrating the fibrous semi-finished product 80 and for displacing fibrous material, and to this end has a substantially cylindrical pin having a tapered point. The screw-in shaft 12 can optionally also be embodied for at least partially anchoring the screw-in insert 10 in the fibrous semi-finished product 80. A linking portion 13 is to be understood as a portion of the screw-in insert 10 which is provided for linking further components (not illustrated).

To this end, the linking portion 13 can be an internal thread, for example, which can be seen in particular in FIG. 2 (plan view of the screw-in insert 10). Alternatively however (and thus not illustrated), the linking portion 13 can also be an external thread, a ball element, or a clip element.

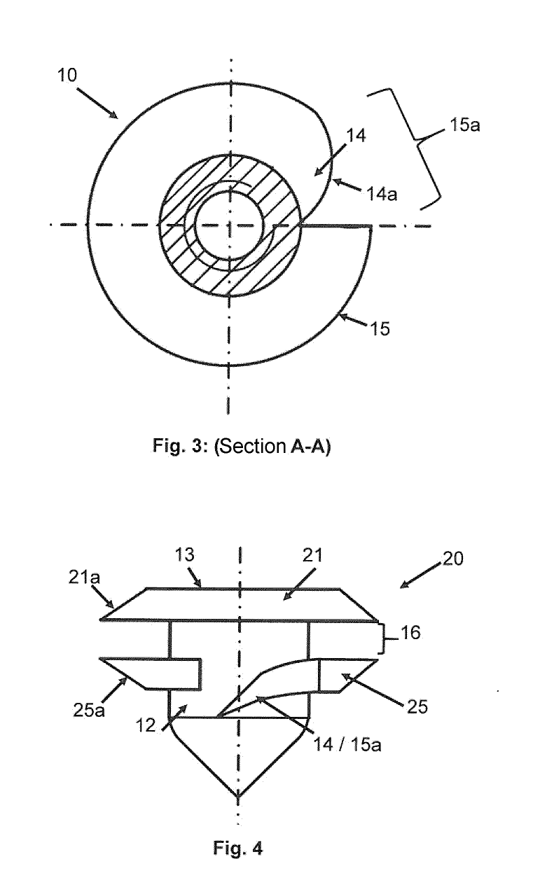

The screw-in insert 10 additionally has a thread blade 14 which is designed for screwing the screw-in insert 10 into the fibrous semi-finished product 80. To this end, the screw-in shaft 12 has a cylindrical portion on which a substantially disk-shaped flange 15 is disposed so as to be spaced apart from the activation portion 11. As can be seen in particular from FIG. 1 and from the sectional view A-A illustrated in FIG. 3, the flange 15 has a flange portion 15a which on a side that faces away from the activation portion 11 projects from a flange plane F (perpendicular to the image plane) that is defined by the flange 15, in order for the thread blade 14 to be formed. Additionally, an external edge 14a of the thread blade 14 is shaped so as to be bent in the direction of the screw-in shaft 12, in order for the fibrous semi-finished product 80 to be penetrated more easily.

The activation portion 11 is additionally configured so as to be disk-shaped such that a receptacle portion 16 for receiving the fibrous semi-finished product 80 is defined between the activation portion 11 and the flange 15 that is disposed so as to be spaced apart.

The thread blade 14, formed by the projecting flange portion 14, when being screwed into the fibrous semi-finished product 80 thus penetrates the fibrous structure of the fibrous semi-finished product 80 such that said fibrous structure is displaced in the direction of the activation portion 11 and, by virtue of the rotating movement of the screw-in insert 10, is driven into the receptacle portion 16, as is illustrated and described in FIGS. 7A to 7D.

A side view of a screw-in insert 20 in a second embodiment is illustrated in FIG. 4, said second embodiment corresponding substantially to the screw-in insert 10 of the first embodiment that has already been illustrated in FIGS. 1, 2, and 3, such that reference is made to the respective description, and the respective elements, to the extent of being identical, are identified by the same reference signs.

By contrast to the first embodiment, the screw-in insert 20 according to the second embodiment has an activation portion 21 which includes a chamfer 21a that faces the first tool part. The chamfer 21a is consequently disposed so as to face away from the disk-shaped flange 25. Moreover, a chamfer 25a that faces the second tool part is also disposed on the disk-shaped flange 25. The chamfer 25a is consequently disposed so as to face away from the activation portion 21.

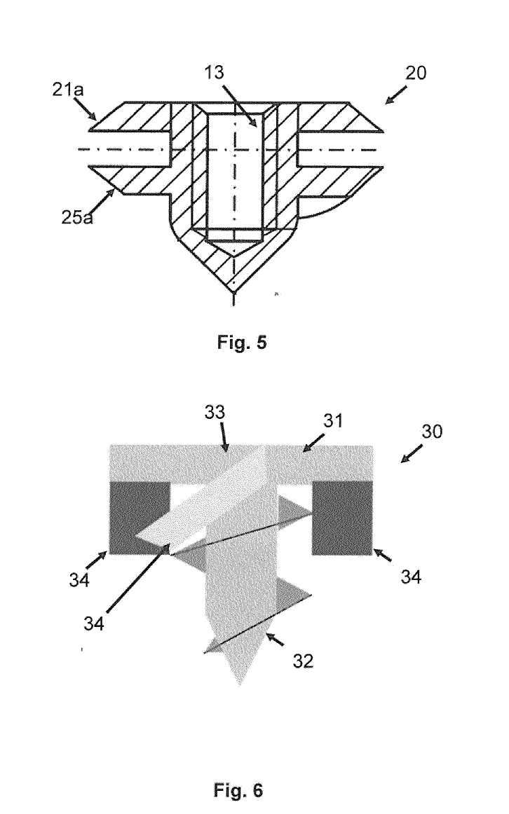

A sectional view of the screw-in insert 20 from FIG. 4 is additionally illustrated in FIG. 5. With the exception of the chamfers 21a, 25a, said view of insert element 20 from FIG. 4 likewise applies to the first embodiment according to FIGS. 1 to 3, showing the linking portion 13 that is embodied as an internal thread.

FIG. 6 shows a side view of a screw-in insert 30 according to a third embodiment. Accordingly, the screw-in insert 30 likewise has an activation portion 31, a screw-in shaft 32 that extends away from the activation portion 31, and a linking portion 33.

However, the screw-in shaft 32 in the embodiment illustrated comprises an external thread for screwing into the fibrous semi-finished product 80. Additionally, four thread blades 34 (merely three thread blades are illustrated) which are designed for screwing the screw-in insert 30 into the fibrous semi-finished product 80 and anchoring said screw-in insert 30 in the latter are provided. The thread blades 34 on the activation portion 31 are disposed so as to be spaced apart in parallel to the screw-in shaft 32, and in the circumferential direction of the activation portion 31 are disposed so as to be mutually spaced apart at equal spacings.

FIGS. 7A, 7B, 7C, and 7D show four steps of a method for producing a fiber-composite component 81 having an integrated screw-in insert 20, according to the second embodiment. However, it is understood that other screw-in inserts 10, 30, in particular the screw-in inserts 10, 30 according to the first or the third embodiment that are illustrated in FIGS. 1 to 6 can also be employed in the same manner.

An initial position in which a provided pressing tool 70 (illustrated in a merely fragmented and heavily simplified manner) comprises a first tool part 71, embodied as the upper tool, and a second tool part 72, movable in relation to said first tool part 71 and embodied as the lower tool, is illustrated in FIG. 7A. Of course, the first tool part can however also be provided as the lower tool, and the second tool part can be provided as the upper tool.

Both tool parts 71, 72 are movable in relation to one another in order for a cavity 74 for receiving the fiber-composite component 81 in a shape-imparting manner to be formed in a closed state of the pressing tool 70.

The screw-in insert 20 according to the second embodiment described in FIGS. 4 and 5 is connected to a screw-driving device 73 that is integrated in the first tool part 71, and the fibrous semi-finished product 80 is disposed between the first 71 and the second tool part 72, wherein the fibrous semi-finished product 80 is provided in a state in which the latter is impregnated with a matrix and is not cured.

The pressing tool 70 according to FIG. 7B is at least partially closed. Additionally, an activation of the screw-driving device 73 for screwing the screw-in insert 20 into the fibrous semi-finished product 80 by means of a screw-driving element 73a which with the aid of a thread (not illustrated) is movable in a rotational manner and in a longitudinal manner in the direction of the cavity 74.

The screw-driving element 73a is embodied in a pin-shaped manner and on an end side is embodied for impinging the screw-in insert in a corresponding manner, in the embodiment illustrated by way of a merely optional appendage 73b in order for the form-fitting impingement to be achieved.

First, the screw-in shaft 12 by way of the tip thereof penetrates the fibrous semi-finished product 80 and displaces part of the fibrous structure. As the depth increases, the projecting flange portion 15a reaches the fibrous semi-finished product 80 and is screwed into the fibrous structure. As has already been described, the fibrous semi-finished product 80 is displaced in the direction of the activation portion 21, and by virtue of the rotating movement of the screw-in insert 20 is driven into the receptacle portion 16.

The fibrous semi-finished product 80 herein in a localized manner is displaced and on a rear side of the disk-shaped flange 25 slides into the defined receptacle portion 16, as is illustrated in FIG. 7C. The screw-in insert 20 in this state by way of the disk-shaped activation portion 21, on the one hand, and by way of the disk-shaped flange 25, on the other hand, is fixed to and held on the fibrous semi-finished product 80, or is supported thereon, respectively, such that a transmission of high forces becomes possible.

The pressing tool 70 can optionally be designed in such a manner that the projecting flange portion 15a (cf. FIG. 4), subsequent to screwing in that is performed in this manner, is deformed in that the screw-in insert 20 is pressed against the opposite tool part, presently the lower tool part 72, for example by means of the screw-driving element 73a, and/or in that the pressing tool 70 is closed to a further degree. In this way, a level lower side of the screw-in insert 20 which is defined by that surface of the disk-shaped flange 25 that faces the second tool part 72, is produced, thus preventing the screw-in insert 20 from being released from the fibrous semi-finished product 80.

Subsequent to incorporating the screw-in insert 20 in the fibrous semi-finished product 80 as described, curing of the fibrous semi-finished product 80 under an impingement with temperature and/or pressure is performed in the pressing tool 70 in order for the fiber-composite component 81 to be produced.

Preferably, the screw-driving device 73 or at least the screw-driving element 73a should be moved back prior to opening the pressing tool 70, in order for an engagement in the screw-in insert 20 to be released and a removal of the fiber-composite component 81 that has been produced in the manner described to be facilitated. It is understood that the step of moving back the screw-driving device 73 or at least the screw-driving element 73a can alternatively be performed already prior to curing.

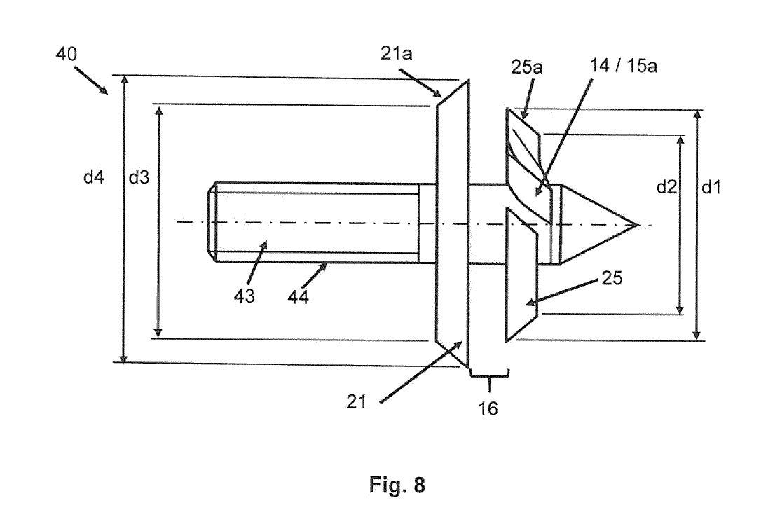

A side view of a screw-in insert 40 in a fourth embodiment which corresponds substantially to the screw-in insert 20 of the second embodiment that has already been illustrated in FIG. 4 is illustrated in FIG. 8, such that reference is made to the respective description, and the respective elements, to the extent of being identical, are identified by the same reference signs.

By contrast to said second embodiment illustrated in FIG. 4, the screw-in insert 40 according to the fourth embodiment has a linking portion 43 which comprises a cylindrical portion which has an external thread 44 for connecting to other components and connecting means (not illustrated).

Additionally, a diameter d1 of the disk-shaped flange 25 is smaller than a diameter d4 of the activation portion 21. In the case of the chamfers 21a, 25a that are optionally provided, this is to be understood in such a manner that the respective largest diameter d1 of the disk-shaped flange 25 is smaller than the largest diameter d4 of the activation portion 21, and the smallest diameter d2 of the disk-shaped flange 25 is smaller than the smallest diameter d3 of the activation portion 21. Moreover, in a merely optional manner, the largest diameter d1 of the disk-shaped flange 25 can be dimensioned so as to be smaller or equal to the smallest diameter d3 of the activation portion 21.

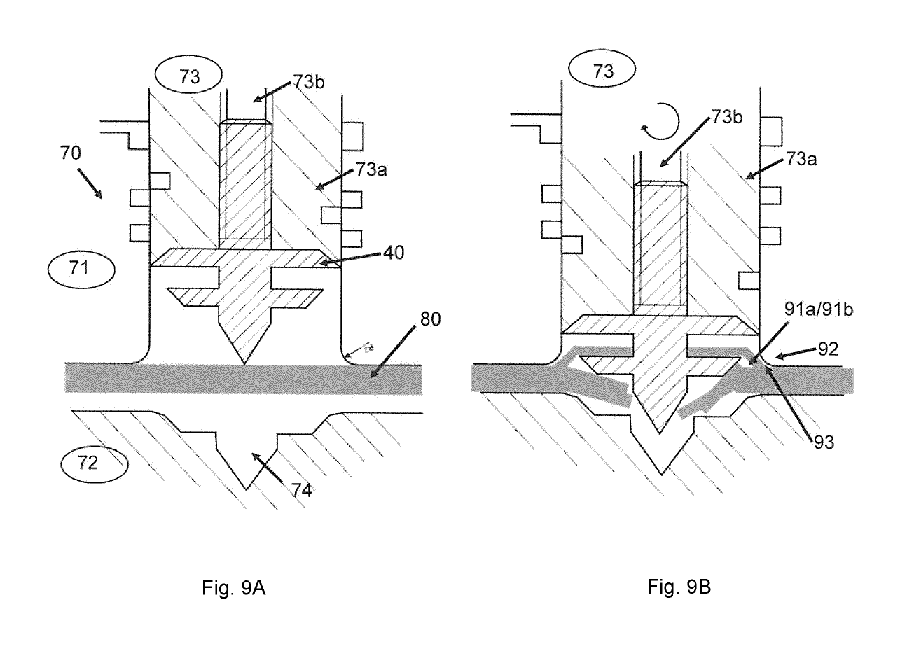

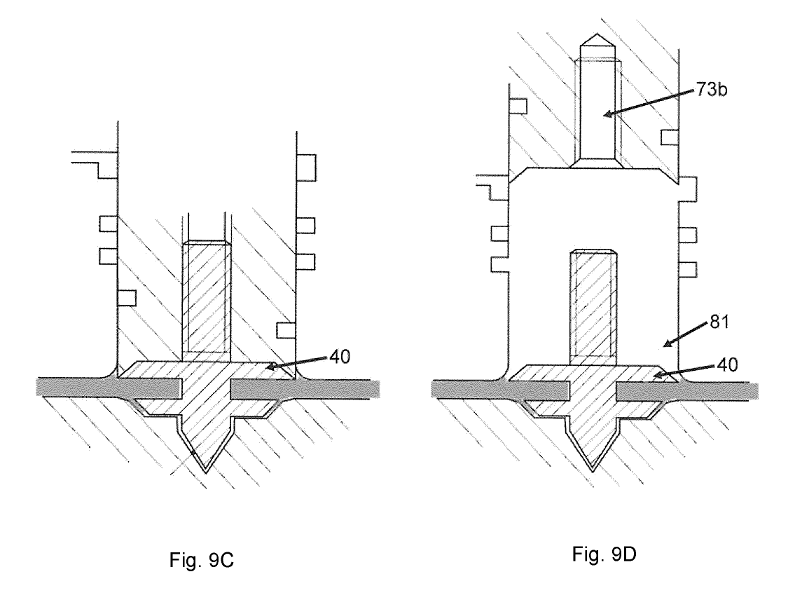

FIGS. 9A, 9B, 9C, and 9D show four steps of a method for producing a fiber-composite component 81 having an integrated screw-in insert 40, according to the fourth embodiment. The individual steps correspond substantially to the steps that have already been described in the context of FIGS. 7A to 7D, such that reference is made to the description that has already been offered in the context of said FIGS. 7A to 7D. The latter thus also applies to the steps of FIGS. 9A to 9D such that only the points of differentiation and the particularities which result from the use of the screw-in insert 40 of the fourth embodiment are described hereunder. However, it is understood that other screw-in inserts 10, 20, 30, in particular the screw-in inserts 10, 20, 30 according to the first, second, or third embodiment that are illustrated in FIGS. 1 to 6 can also be employed in the same manner.

The screw-in insert 40 in FIG. 9A is connected to the screw-driving device 73 that is integrated in the first tool part 71, and the fibrous semi-finished product 80 is disposed between the first 71 and the second tool part 72, wherein the fibrous semi-finished product 80 is provided in a state in which the latter is impregnated with a matrix and not cured.

The pressing tool 70 according to FIG. 9B is at least partially closed. An activation of the screw-driving device 73 for screwing the screw-in insert 40 into the fibrous semi-finished product 80 by means of the screw-driving element 73a which with the aid of a thread (not illustrated) is movable in a rotational manner and in a longitudinal manner in the direction of the cavity 74 is additionally performed. The screw-driving element 73a is embodied so as to be pin-shaped and in the region of an end side is provided with an internal thread 73b for connecting to the external thread 44 of the screw-in insert 40.

The screw-in insert 40 by way of the tip of the screw-in shaft 12 is first incorporated into the fibrous semi-finished product 80, and displaces part of the fibrous structure. As the depth increases, the projecting flange portion 15a (cf. FIG. 8) reaches the fibrous semi-finished product 80 and is screwed into the fibrous structure. The fibrous semi-finished product 80 is displaced in the direction of the activation portion 21 and by virtue of the rotating movement of the screw-in insert 40 is driven into the receptacle portion 16.

The diameter d1 of the flange 25 is optionally chosen so as to be smaller than the diameter d3 of the activation element 21 such that a gap 91a is generated between the first tool part 71 and the flange 25, on account of which the fibrous semi-finished product 80 can be more easily and readily incorporated into the receptacle portion 16. Tearing of the fibrous structure is avoided in this way.

Additionally or alternatively to this choice of the diameters, on the surface of the first tool part 71 that delimits the cavity 74, a clearance 93, for example in the form of a chamfer or of a rounded feature, can be provided in the first tool part 71 in the region of a mouth 93 of the screw-driving device 73, in order to likewise generate a gap 91b between the first tool part 71 and the flange 25, or for the existing gap 91a that is provided by the choice of diameter mentioned to be enlarged such that the fibrous semi-finished product 80 can more easily and reliably be incorporated into the receptacle portion 16. Tearing of the fibrous structure is likewise reliably avoided.

The steps carried out in FIGS. 9C and 9D correspond to the steps illustrated in FIGS. 7C and 7D.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a fiber-composite component having an integrated screw-in insert, the method comprising the acts of:
providing a pressing tool having a first tool part and a second tool part that is movable relative to the former, said first tool part and said second tool part in a closed state of the pressing tool forming a cavity for receiving a fibrous semi-finished product in a shape-imparting manner;
connecting a screw-in insert to a screw-driving device that is integrated in the first tool part;
disposing the fibrous semi-finished product between the first and the second tool part;
at least partially closing the pressing tool;
activating the screw-driving device for screwing the screw-in insert into the fibrous semi-finished product; and
curing the fibrous semi-finished product in order for the fiber-composite component to be generated.

2. The method as claimed in claim 1, wherein
the fibrous semi-finished product is disposed in the pressing tool in a state in which said fibrous semi-finished product is impregnated with a matrix and is not cured.

3. The method as claimed in claim 1, wherein
the act of at least partially closing comprises completely closing the pressing tool.

4. The method as claimed in claim 1, further comprising the act of:
completely closing the pressing tool prior to the act of curing the fibrous semi-finished product.

5. The method as claimed in claim 1, further comprising the act of:
reversing at least a screw-driving element of the screw-driving device, prior to the pressing tool being opened.

6. A screw-in insert for screwing into a fibrous semi-finished product, comprising:
an activation portion;
a screw-in shaft that extends away from the activation shaft; and
a linking portion.

7. The screw-in insert as claimed in claim 6, wherein
the linking portion comprises an internal thread, an external thread, a ball element, a bayonet element or a clip element.

8. The screw-in insert as claimed in claim 6, wherein
the screw-in insert comprises at least one thread blade which is designed for screwing the screw-in insert into the fibrous semi-finished product and anchoring said screw-in insert in the latter.

9. The screw-in insert as claimed in claim 8, wherein
the screw-in shaft has a cylindrical portion on which a substantially disk-shaped flange is disposed so as to be spaced apart from the activation portion,
the flange, in order for the at least one thread blade to be formed, has at least one flange portion which projects from a flange plane that is defined by the flange.

10. The screw-in insert as claimed in claim 9, wherein
the activation portion has a chamfer that faces away from the disk-shaped flange, and/or
the disk-shaped flange has a chamfer that faces away from the activation portion.

11. The screw-in insert as claimed in claim 8, wherein
the activation portion is configured so as to be disk-shaped, and a receptacle portion for receiving the fibrous semi-finished product is defined between the activation portion and the flange that is disposed so as to be spaced apart.

12. The screw-in insert as claimed in claim 8, wherein
the screw-in shaft comprises an external thread for screwing into the fibrous semi-finished product, and
the at least one thread blade on the activation portion is disposed so as to be spaced apart in parallel with the screw-in shaft.

13. A pressing tool, comprising:
a first tool part and a second tool part, wherein
the two tool parts in a closed state form a cavity for receiving a fibrous semi-finished product in a shape-imparting manner, and
at least one tool part for screwing a screw-in insert into the fibrous semi-finished product to be disposed in the cavity has a screw-driving device which is activatable in the direction of the cavity.

14. The pressing tool as claimed in claim 13, wherein
the screw-driving device comprises a screw-driving element that is movable in a rotational manner and in a longitudinal manner in the direction of the cavity, said screw-driving element for impinging a screw-in insert in a form-fitting manner being configured with a connecting portion that faces the cavity.

15. The pressing tool as claimed in claim 13, wherein
the screw-driving device is configured so as to be retractable into the tool part.

16. The pressing tool as claimed in claim 13, wherein
the pressing tool is a wet pressing tool.
